(19) United States
(12) Patent Application Publication
(10) Pub. No.: US 2011/0110089 A1
(43) Pub. Date: May 12, 2011

(54) 360-DEGREE ANGLE LED ILLUMINATION DEVICE

(75) Inventors: Chia-Cheng CHANG, Taipei County (TW); Rong-Ming CHANG, Taipei County (TW)

(73) Assignee: Chia-Cheng Chang

(21) Appl. No.: 12/615,187

(22) Filed: Nov. 9, 2009

(51) Int. Cl. F21S 4/00

(52) U.S. Cl. 362/249.06; 362/249.02

(57) ABSTRACT

A 360-degree angle LED (light-emitting diode) illumination device comprises a copper base plate, a plurality of LED chips, and a flexible PCB circuit layer. The copper base plate is electroplated with a layer of silver thereon. The plurality of LED chips is provided on the peripheries of the copper base plate. The flexible PCB circuit layer is provided on the peripheries of the copper base plate and electrically connected with the LED chips for controlling the LED chips. Accordingly, it is able to provide 360-degree angle illumination range and to improve the thermal conductivity and heat dissipation capability in order to prolong effectively the lifetime of the LED chips in use.

### TECHNICAL FIELD

The present invention relates to a LED (light-emitting diode) illumination device and, more particularly, to a 360-degree angle LED illumination device capable of providing 360 degree illumination range and advantageous of having lower manufacturing cost and improved the thermal conductivity and heat dissipation capability in order to prolong the lifetime of the LED chips while having.

### BACKGROUND

Typically, a plurality of LEDs (light-emitting diodes) are arranged on the same plane of a main body to form a conventional LED illumination device in order to provide wider illumination range and better illumination intensity. By using above planar type LED illumination devices, it is able to obtain 180-degree illumination range after the LEDs are driven.

Although 180-degree illumination range can be achieved by means of above LED arrangement, the practical illumination effect provided by above LED illumination devices is not ideal. In order to widen the illumination range, two planar type LED illumination devices are combined to form a new device, the illumination range of which is over 360 degrees.

However, it is also disadvantageous in several aspects to combine two planar type LED illumination devices mentioned hereinabove.

First of all, dead angles still exist even two planar type LED illumination devices are combined and it is unable to achieve 360-degree angle illumination range. Second, the assembling cost for combining two planar type LED illumination devices is greatly increased. Besides, assembling two planar type LED illumination devices not only requires highly complicated and difficult technical skills but also takes much longer time. Moreover, the yield of the devices produced by assembling two planar type LED illumination devices is low as well.

In order to overcome above shortcomings, inventor had the motive to study and develop the present invention. After hard research and development, the inventor provides a 360-degree angle LED illumination device capable of providing 360-degree angle illumination range and advantageous in having lower manufacturing cost and having improved thermal conductivity and heat dissipation capability in order to prolong the lifetime of the LED chips in use.

### SUMMARY OF THE DISCLOSURE

An object of the present invention is to provide a 360-degree angle LED (light-emitting diode) illumination device, which is formed by arranging plural LED chips on the peripheries of a single copper base plate. Thereby, LED chips are able to illuminate in different angle ranges in order to achieve 360-degree angle illumination range.

Another object of the present invention is to provide a 360-degree angle LED illumination device, where the copper base plate is electroplated with a layer of silver thereon. Thereby, the thermal conductivity and heat dissipation capability can be improved in order to prolong the lifetime of the LED chips in use while keep manufacturing cost low.

In order to achieve above objects, the present invention provides a 360-degree angle LED illumination device comprising a copper base plate, a plurality of LED chips, and a flexible PCB circuit layer. The copper base plate is electroplated with a layer of silver thereon. The plurality of LED chips is provided on the peripheries of the copper base plate. The flexible PCB circuit layer is provided on the peripheries of the copper base plate and electrically connected with the LED chips for controlling the LED chips. Accordingly, it is able to provide 360-degree angle illumination range and to improve the thermal conductivity and heat dissipation capability in order to prolong the lifetime of the LED chips in use effectively.

In practice, the copper base plate is preferably in octagonal shape and four lateral sides thereof are respectively provided with a LED chip.

The following detailed description, given by way of examples or embodiments, will best be understood in conjunction with the accompanying drawings.

### BRIEF DESCRIPTION OF THE DRAWINGS

FIG. 1 shows a perspective view of a first embodiment of a 360-degree angle LED illumination device of the present invention.

FIG. 2 shows a perspective view of a second embodiment of a 360-degree angle LED illumination device of the present invention.

FIG. 3 is a schematic view showing the use of the 360-degree angle LED illumination device in the second embodiment of the present invention.

### DETAILED DESCRIPTION

The present invention discloses a 360-degree angle LED (light-emitting diode) illumination device comprising a copper base plate, a plurality of LED chips, and a flexible PCB circuit layer. The plurality of LED chips is provided on the peripheries of the copper base plate. The flexible PCB circuit layer is provided on the peripheries of the copper base plate and electrically connected with the LED chips for controlling the LED chips.

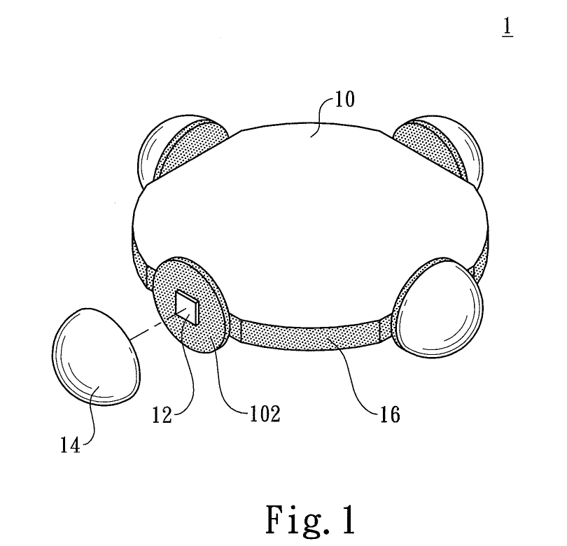

Please refer to FIG. 1 showing a first embodiment of a 360-degree angle LED illumination device of the present invention. In this embodiment, the 360-degree angle LED illumination device 1 comprises a copper base plate 10, four LED chips 12, four covers 14, and a flexible PCB circuit layer 16.

Besides, in this embodiment, the copper base plate 10 is in octagonal shape and is electroplated with a layer of silver thereon for obtain optimal thermal conductivity and heat dissipation capability.

Heat will be inevitably produced when LED chips are used. If the produced heat is unable to dissipate effectively, the temperature of the LED chips will be elevated accordingly, which may shorten the lifetime of the LED chips. In order to solve this problem and prolong the lifetime of LED chips, metal is typically used to dissipate produced heat because of good thermal conductivity and heat dissipation capability.

In this embodiment, copper and silver are used as the material to solve the problem regarding thermal conductivity and heat dissipation. The thermal conductivity coefficient of copper is 380 W/m.K while the thermal conductivity coefficient of silver is 429 W/m.K. Accordingly, silver has better thermal conductivity when compared with copper. However, copper is much cheaper than silver.

Therefore, in the present invention, the copper is used as a core for thermal conductivity and heat dissipation and silver is electroplated on the surface of the core made of copper. In other words, copper and silver are used to form an alloy whose thermal conductivity is between those of copper and silver. Accordingly, better thermal conductivity and hear dissipation capability can be achieved while the cost can be kept low.

In practice, the thermal conductivity coefficient of the copper base plate electroplated with a layer of silver is about 420 W/m.K. That is, the thermal conductivity of the copper base plate electroplated with a layer of silver is almost the same with that of silver while the cost of the electroplated copper base plate is much cheaper than that of silver. Besides, in addition to the better thermal conductivity and hear dissipation capability, the silver electroplated on the copper base plate is also able to provide reflection effect that is beneficial to increase effective luminous flux.

Besides, four lateral sides of the copper base plate 10 respectively form a receiving part 102 for placing a LED chip 12 thereon. Moreover, Each LED chip is covered with a cover 14. By the arrangement of the LED chips, LED chips are able to illuminate in different angle ranges. Therefore, it is able to obtain 360-degree angle illumination range and decrease dead angles effectively.

In this embodiment, the flexible PCB circuit layer 16 is provided on the peripheries of the copper base plate 10 and electrically connected with the LED chips 12 for controlling the LED chips 12.

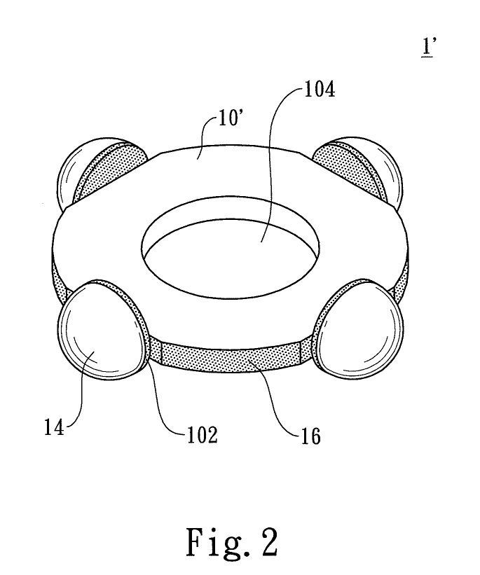

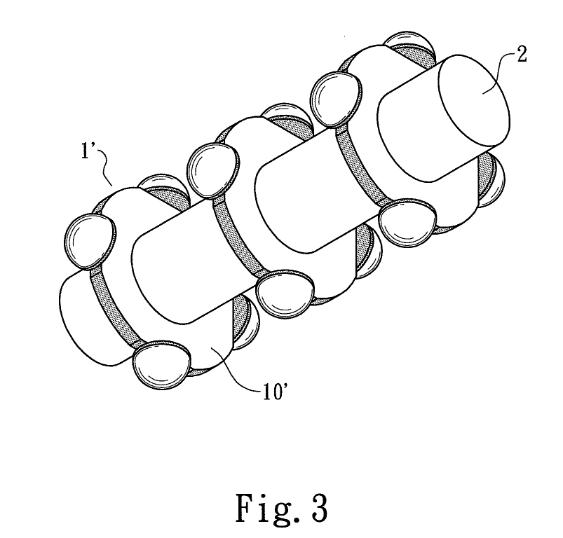

Please refer to FIGS. 2 and 3 showing a second embodiment of the present invention. The only difference between these two embodiments is that the structure of the copper base plate 10′ is altered. As shown in FIG. 2, the copper base plate 10′ is further provided with a hole 104 centrally. By means of this design, as shown in FIG. 3, plural 360-degree angle LED illumination devices can be strung to form a new illumination devices. Accordingly, various illumination devices composed of plural 360-degree angle LED illumination devices can be formed in response to different requirements from consumers.

Therefore, the present invention has following advantages:
1. By arranging a plurality of LED chips on the peripheries of a single copper base plate, it is able to obtain 360-degree angle illumination range while effectively decrease dead angles.
2. The alloy formed by electroplating a layer of silver on the surface of a copper base plate has ideal thermal conductivity and heat dissipation capability and low manufacturing cost.
3. By electroplating a layer of silver on the surface of a copper base plate, the electroplated silver can provide better reflection effect in order to increase the effective luminous flux.
4. By providing the copper base plate with a hole, it is able to string plural 360-degree angle LED illumination devices to form a new illumination device with better illumination effect.

As disclosed in the above description and attached drawings, the present invention can provide a 360-degree angle LED illumination device capable of providing 360-degree illumination range and advantageous in having improved the thermal conductivity and heat dissipation capability in order to prolong the lifetime of the LED chips in use while keeping the manufacturing cost low. It is new and can be put into industrial use.

Although the embodiments of the present invention have been described in detail, many modifications and variations may be made by those skilled in the art from the teachings disclosed hereinabove. Therefore, it should be understood that any modification and variation equivalent to the spirit of the present invention be regarded to fall into the scope defined by the appended claims.

What is claimed is:

1. A 360-degree angle LED (light-emitting diode) illumination device, comprising:
a copper base plate, electroplated with a layer of silver;
a plurality of LED chips, provided on the peripheries of the copper base plate; and
a flexible PCB circuit layer, provided on the peripheries of the copper base plate and electrically connected with the LED chips for controlling the LED chips.

2. The 360-degree angle LED illumination device as claimed in claim 1, wherein the copper base plate is in octagonal shape and four lateral sides thereof are provided with a LED chip respectively.

3. The 360-degree angle LED illumination device as claimed in claim 2, wherein each LED chip is further covered by a cover.

4. The 360-degree angle LED illumination device as claimed in claim 2, wherein the copper base plate is further provided with an opening centrally.

5. The 360-degree angle LED illumination device as claimed in claim 1, wherein each LED chip is further covered by a cover.

6. The 360-degree angle LED illumination device as claimed in claim 1, wherein the copper base plate is further provided with an opening centrally.
